(19) United States
(12) Patent Application Publication
(10) Pub. No.: US 2021/0201937 A1
(43) Pub. Date: Jul. 1, 2021

(54) ADAPTIVE DETECTION THRESHOLD FOR NON-STATIONARY SIGNALS IN NOISE

(71) Applicant: TEXAS INSTRUMENTS INCORPORATED, Dallas, TX (US)

(72) Inventors: Charles Kasimer SESTOK, IV, Dallas, TX (US); David Patrick MAGEE, Allen, TX (US); Tarkesh PANDE, Richardson, TX (US)

(21) Appl. No.: 16/895,827

(22) Filed: Jun. 8, 2020

Related U.S. Application Data
(60) Provisional application No. 62/955,580, filed on Dec. 31, 2019.

(51) Int. Cl. G10L 25/84

(52) U.S. Cl. CPC G10L 25/84

(57) ABSTRACT

Techniques for target input detection, including receiving input data, dividing the input data into data blocks, determining a detection feature value for a first data block, determining a detection threshold based on a set of detection feature statistics determined for a background sampling time period, and determining a target signal has been received based on a comparison between the detection feature value for the first data block to the detection threshold.

### CROSS-REFERENCE TO RELATED APPLICATION

This application claims priority to U.S. Provisional Application Ser. No. 62/955,580 titled “Adaptive Detection Threshold for Non-Stationary Signals in Noise,” filed Dec. 31, 2019, and which is herein incorporated by reference in its entirety.

### BACKGROUND

Detection of signals or environmental conditions of interest is an important application for sensor-enabled electronic systems. Common sensing techniques may involve monitoring acoustic, mechanical, or electromagnetic signals to detect the target phenomenon. In such systems, a sensing element such as a microphone, accelerometer, or antenna captures incoming signals and background noise, producing an electrical signal as an output. This signal is processed by an electronic system that helps identify or detect the signal or conditions of interest from out of the background noise or interference. The detection process typically computes a function of the input signal, often referred to as a feature, and compares the feature to a number called a detection or test threshold. If the feature exceeds the threshold, the system indicates the potential presence of the signal or condition of interest. When this signal or condition is actually present, the system has made a correct detection. In cases where the system indicates the presence of the signal or condition of interest, and the signal or condition is not actually present, the system has raised a false alarm. In signal detection, maintaining a constant false alarm rate regardless of the change in background noise or interference is 4300-0715US a common system design goal. The constant false alarm rate helps avoid frequent activation of subsequent actions in response to the signal or condition of interest. These subsequent actions, such as additional processing, on the falsely detected signal or condition can consume significant energy or time. In order to achieve the constant false alarm rate performance, systems continually monitor sensor input and adjust or adapt the detection threshold to maintain the false alarm rate.

Speech processing systems are an example of a signal detection system. playing an increasing role in everyday lives such as for hands-free vehicle operation, telephone menus, and digital assistants. Speech processing systems commonly operate in an always-on manner, constantly listening for specific commands or keywords. Speech processing systems may include voice activity detection (VAD) circuits to help detect when an input audio signal includes speech. For a speech processing system, the signal or condition of interest is human speech. Other acoustic signals generated by machinery, climate control, crowds, or other audio devices are generally the background noise and/or interference. VAD circuits may be used to activate additional, speech specific signal processing in response to detecting audio input that includes speech. Speech specific signal processing can be energy intensive and it is desirable to deactivate this processing when there is no speech detected, for example, in an empty room.

Common VAD system designs attempt to maintain the false alarm rate of the detector despite uncertainty in the exact statistics of background noise using a detection threshold that scales the measured acoustic signal sample standard deviation by a fixed gain. Such threshold adaptation algorithms tend to maintain a constant false alarm rate in Gaussian noise of unknown variance. However, such systems tend not to perform well in the presence of highly non-Gaussian background noise, such as an environment where the background noise varies like a subway or in an interior of a moving car. Thus, what is needed is a technique for more efficiently determining a threshold parameter to more accurately determine the presence of speech despite uncertainty around the characteristics of background noise.

### SUMMARY

This disclosure relates to techniques for target input detection, including receiving input data, dividing the input data into data blocks, determining a detection feature value for a first data block, determining a detection threshold based on a set of detection feature statistics determined for a background sampling time period, and determining a target signal has been received based on a comparison between the detection feature value for the first data block to the detection threshold.

Another aspect of the present disclosure relates to a target input detection circuit, including receiving circuitry configured to receive input data, windowing circuitry configured to divide the input data into data blocks, transformation circuitry configured to determine a detection feature value for a first data block, detection threshold circuitry to determine a detection threshold based on a set of detection feature statistics determined for a background sampling time period, and determine a target signal has been received based on a comparison between the detection feature value for the first data block to the detection threshold.

Another aspect of the present disclosure relates to an electronic device including one or more processors, a non-transitory program storage device including instructions stored thereon to cause the one or more processors to receive input data divide the input data into data blocks, determine a detection feature value for a first data block, determine a detection threshold based on a set of detection feature statistics determined for a background noise sampling time period, and determine a signal has been received based on a comparison between the detection feature value for the first data block to the detection threshold.

### BRIEF DESCRIPTION OF THE DRAWINGS

For a detailed description of various examples, reference will now be made to the accompanying drawings in which:

FIG. 1 illustrates an example VAD system, in accordance with aspects of the present disclosure.

FIG. 2 illustrates a detection threshold adaption state machine in accordance with aspects of the present disclosure.

FIG. 3 illustrates a charted energy entropy feature and peak hold metric, in accordance with aspects of the present disclosure.

FIG. 4 illustrates an adaptive circuit, in accordance with aspects of the present disclosure.

FIG. 5 is a block diagram illustrating an adaptive detection threshold VAD circuit, 500, in accordance with aspects of the present disclosure

FIG. 6 is a flow diagram illustrating a technique for audio input detection, in accordance with aspects of the present disclosure.

FIG. 7 is a block diagram of an embodiment of a computing device, in accordance with aspects of the present disclosure.

### DETAILED DESCRIPTION

Voice detection and activation upon voice detection are often used to wake or otherwise activate systems upon detection of speech. Often such systems spend the majority of their time in an environment without detectable speech. As an example, a voice activated virtual assistant may spend most of its time in a quiet room, listening for its wake word. To save power, such systems may often be at least partially powered down. For example, speech specific processing circuits typically consume more power than circuits for detecting the presence of speech and may be powered down when speech is not detected. The VAD system may continue to operate while the speech specific systems are powered down. The VAD system receives audio input data, for example, for one or more microphones and quickly analyzes the audio input data to determine whether the audio input data includes potential speech, or just background noise. If speech is detected, the VAD system can, for example, wake up other speech specific signal processing systems, such as speech recognition systems.

In certain cases, a VAD system for noisy environments may utilize an average energy and entropy of an audio signal as a metric to determine whether the audio signal includes speech. Such a system may use a product between the energy in an audio block, such as an audio signal of a certain time period, and entropy of a probability distribution derived from the power spectrum of the audio block. The difference between these quantities in a current audio block and corresponding quantities from an audio block of background noise may be compared to determine whether the current block includes speech.

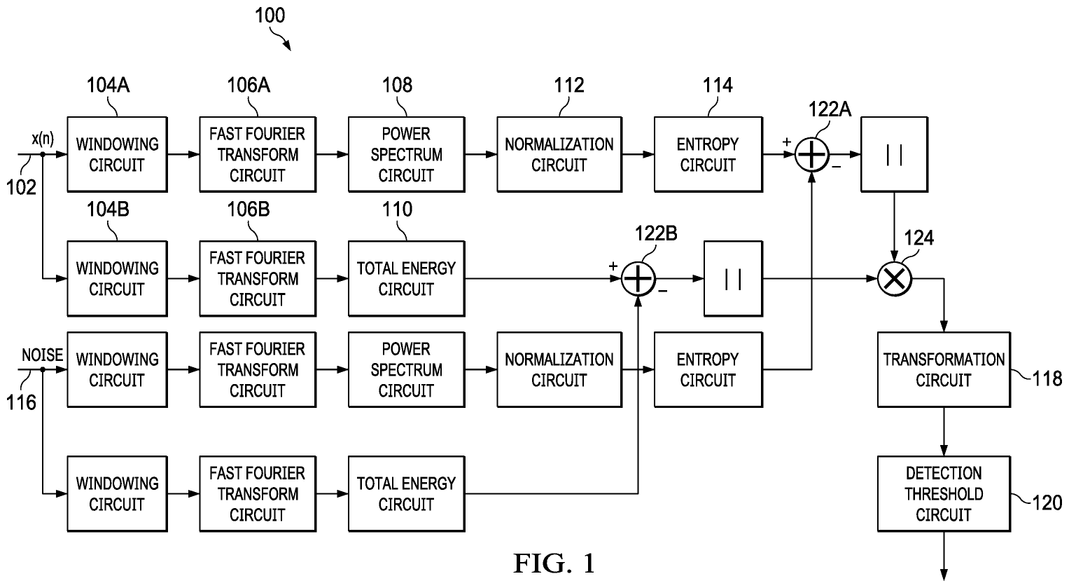

FIG. 1 illustrates an example VAD system 100, in accordance with aspects of the present disclosure. A sampled input signal x[n] 102 is received by signal receiving circuitry in the VAD system 100 and a power spectrum and total energy of the input signal 102 may be analyzed. To do so, the input signal 102 may be divided into blocks of data using windowing circuitry 104A and 104B performing a windowing function. In certain cases, the windowing circuitry 104A and 104B utilize a windowing function, such as a Hamming window, which is multiplied against the sampled input signal 102 to produce a zero value outside a window interval. The window function is non-zero over a finite region within the window interval, such as 0≤n≤B−1. The windowed data is denoted x_{w,a}[n]=w[n]x[aB+n] for a window of length B and the variable a, where a represents a particular frame or block from the input signal selected based on the data window and w indicates that the input signal has been multiplied with the data window. The shift by aB places the selected data within the support region of the window function. Audio data for a time period selected by the window function may be referred to as a block of data or a block of audio data. For a particular block of data, a short-time Fourier transform (STFT) of the block of data may be determined, for example, via a fast Fourier transform (FFT) circuitry 106A and 106B, which transform the block of data by applying an FFT such as

$$X ( k , a ) = {\sum }_{n = 0}^{B - 1} {x}_{w , a} [ n ] {e}^{- j \frac{2 π k n}{N}}$$

to the block of data. The variable k represents the frequency bin of the FFT.

A power spectrum function may be estimated by power spectrum circuitry 108 via the magnitude of the STFT and may be represented by the function S(k, a)=X(k, a)X*(k, a). A Power spectrum describes the distribution of power into frequency components for the block of data. The power spectrum may also be determined via other known techniques, such as via a filter bank or Mel-Frequency Spectral Coefficients.

Total energy circuitry 110 may determine the total energy of the signal by integrating the power spectrum, which may be represented by the equation E(a)=Σₙx_{w}²[n]=ΣₖS(k, a). Here, S represents the power spectrum as discussed above and (k, a) distinguish this function from the states noted with one variable. Generally, the total energy of a signal looks at the area under the square of the signal function.

An energy of the data block is complemented by the entropy of the probability distribution derived from normalizing, via normalization circuitry 112, the power spectrum. As an example, the normalization function can be described by the function

$$P ( k , a ) = \frac{S ( k , a )}{{\sum }_{k} S ( k , a )} .$$

An entropy of the data block may then be found via entropy circuitry 114. The entropy from the normalized PSD may be described by the function H(a)=−ΣₖP(k, a) log₂ P(k, a), where the minus sign is included to make the quantity positive since the logarithm of a probability is always negative as P(k, a)<1 for all (k, a). The energy entropy feature (EEF), may thus be defined as EEF(a)=(E(a)−C_{E}). (H(a)−C_{H}), where the constants C_{E} and C_{H} are representative background values for energy and entropy and the EEF is determined either at the output of a multiplication circuit 124, or an output of a transformation circuitry 118 may be used. In some implementations, a non-linear transform of the data may be applied to compress the dynamic range, for example via a transformation circuitry 118 using a function such as \sqrt{1+|EEF(a)|}.

A noise signal 116 may be obtained during an interval of time where only background noise is present. This noise signal 116 may be analyzed in a manner similar to the analysis of the input signal 102. A difference between the analyzed input signal 102 and the noise signal 116 may be determined by noise subtraction circuits 122A and 122B. The resulting signal may be compared, via detection threshold circuitry 120, to a detection threshold function. In certain systems, the threshold used to determine whether or not speech has been spoken can be determined by applying a scale factor to a time-averaged value for EEF during an interval of time where only background noise is present. If the time averaged value is denoted m_{EEF}(a), a detection threshold such as t_{original}(a)=ρm_{EEF}(a) can be applied. Where the time-averaged value for the input signal 102 goes above the threshold for a number of time instances, then a determination may be made that a speech signal may have been received and speech specific signal processing may be started. However, using a static threshold value for representing background noise may be difficult in cases where the background noise in an input signal can change significantly as compared to the noise signal when the static threshold was determined. Rather, an adaptive detection threshold may be used.

### Adaptive Detection Threshold

According to aspects of the present disclosure, an adaptive detection threshold may be utilized to handle practical situations where the background noise varies. In certain cases, the time average of the EEF may be determined and tracked over lengths of time to help adapt to changes in background noise. In certain cases, a finite impulse response (FIR) implementation may be used to directly compute a weighted sum of EEF values during various time intervals, such as during system startup, or in time intervals selected periodically by a wake-up timer. The FIR time average can be expressed via the function m_{EEF,FIR}(a)=Σₚ₌₀^{L}^{_{FIR}}v[p]EEF(a−pTₘ). Here the sequence v[ρ] represents an impulse response of a finite impulse response (FIR) filter that determines local averages of the EEF sequence to estimate the mean of the signal. The weights used for averaging satisfy the constraint Σₚ₌₁^{L}^{_{FIR}}v[p]=1, and the constant Tₘ represents a background noise sampling time period for a wake-up timer for background noise sampling, measured in number data window durations.

In other cases, determining the time average of EEF may be performed using an infinite impulse response (IIR), or recursive, filter, which can be dynamically adjusted at particular intervals, such as based on a number of blocks or on a timer. In such cases, the time average may be defined based on the equation m_{EEF,IIR}(a)=(1−β)m_{EEF,IIR}(a−Tₘ)+βEEF(a). In this example, a parameter β represents how quickly estimates of the background noise may adapt, with smaller values of β indicating a slower rate of adaptation. The value of m_{EEF,IIR}(a) is held constant for blocks where an update is not computed. Where the mean satisfies m_{EEF,IIR}(a−1)=m_{EEF,IIR}(a−Tₘ), the update equation can be simplified to m_{EEF,IIR}(a)=(1−β)m_{EEF,IIR}(a−1)+βEEF(a).

In certain cases, background noises may include complicated noises, such as in an airport terminal or subway with a variety of disparate noises, which can result in multiple peaks across a time period. In such cases, having the detection threshold take into account both the average value of the EEF as well as the spread may be advantageous. In accordance with aspects of the present disclosure, the threshold may be configured based on the IIR filter incorporating estimates of the mean and standard deviation of the EEF detection metric from the audio background level. In certain cases, the detection threshold may be set at a defined number of standard deviations above the mean metric. This can help control the rate of false alarms due to the audio background noise. Given estimates of the mean m_{EEF}(a) of the EEF sequence and the standard deviation σ_{EEF}(a) of the EEF sequence for data up to and including block a, the detection threshold is given by Equation 1: t(a)=m_{EEF}(a)+rσ_{EEF}(a). The parameter r may be set to control the sensitivity of the VAD algorithm to help adjust the false alarm rate in the audio background.

The mean and variance values of such a detection threshold may be periodically updated, for example triggered by a timer, or based on a specific block count period. For example, updates can be computed every four data blocks, or after a specific amount of elapsed time. Values of the mean and standard deviation may be computed recursively from the EEF sequence. A weight parameter 0<β<1 may be used to update estimates of the mean and variance from a new measurement EEF(a). The updated mean and variance may be given by the equations two and three.

m_{EEF}(a)=EE_{F}(a−Tₘ)+β(EEF(a)−m_{EEF}(a−Tₘ)) Equation 2:

σ_{EEF}²(a)=(1−β)(σ_{EEF}²(a−Tₘ)+β(EEF(a)−m_{EEF}(a−Tₘ))²) Equation 3:

As with the mean-only IIR averaging cases, the mean and variance estimates are constant between updates, and satisfy m_{EEF}(a−1)=m_{EEF}(a−Tₘ) and σ_{EEF}²(a−1)=σ_{EEF}²(a−Tₘ). Equations two and three may then be simplified as equations four and five.

m_{EEF}(a)=m_{EEF}(a−1)+β(EEF(a)−m_{EEF}(a−1)) Equation 4:

σ_{EEF}²(a)=(1−β)(σ_{EEF}²(a−1)+β(EEF(a)−m_{EEF}(a−1))² Equation 5:

To determine the test threshold, a square root of the variance estimate may be determined. In certain cases, the test threshold is similar to the detection threshold and the test threshold tests for the presences of a signal, such as speech, by comparing a feature to the threshold. In certain cases, the threshold may be initialized during initial start-up of the VAD system. During initialization, the recursive update for the mean and variance of the EEF may be computed for N_{init,VAD} consecutive updates. In certain cases, an update for the mean and variance may be run after each block of data instead of after a set update period driven by a timer or counter. After the initialization is complete, the VAD algorithm may run using a background update controlled by the timer or block count period.

The weight parameter follows a gear-shifting sequence during initialization. It is derived from the base-two logarithm of the initialization block count 1≤cᵢₙᵢₜ≤N_{init,VAD}. The weight in a specific initialization block can be defined by the function β(cᵢₙᵢₜ)=1/(2^{└log}^{₂}^{(c}^{ᵢₙᵢₜ}^{)┘}), where the symbol └⋅┘ denotes the integer floor function.

### Periodic Update of Detection Thresholds

Adapting the detection threshold can be further enhanced by controlling when updates can be made to the threshold. For example, updates during loud and/or sustained speech can cause the mean and variance of the EEF to rise to a level higher than necessary to handle background noise, raising the threshold too high to allow the VAD system to properly respond to softer speech. In certain cases, outlier detection and compensation may be utilized to help avoid biasing the detection threshold due to updates taken during speech or other interference.

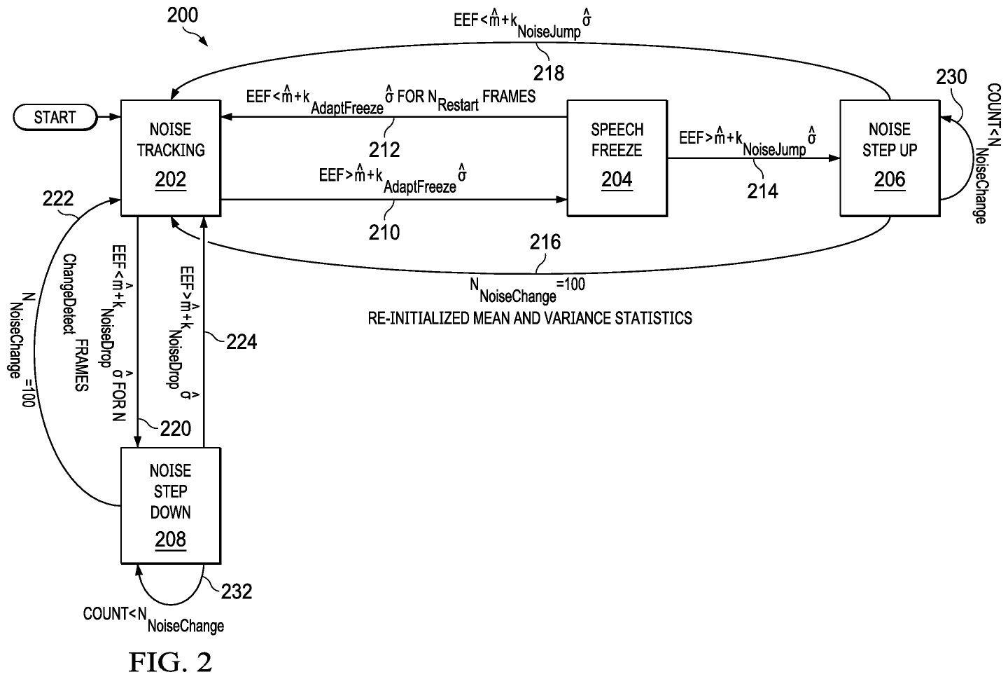

FIG. 2 illustrates a detection threshold adaption state machine 200 in accordance with aspects of the present disclosure. The detection threshold adaption state machine 200 includes a noise tracking state 202, speech freeze state 204, noise step up state 206, and noise step down state 208. The different states of the detection threshold adaption state machine 200 may be used to control the behavior of updates to the mean m_{EEF}(a) and variance σ_{EEF}(a). In certain cases, state transition conditions may be checked for every data block. In this example, the noise tracking state 202 performs the adaptive detection threshold determination and periodically updates the detection threshold, while the speech freeze state 204 stops the threshold updates, and the noise step up 206 and noise step down 208 states help rapidly handle discontinuous changes to the background noise characteristics that can lead to large changes to the detection threshold.

The detection threshold adaption state machine 200 starts in and defaults back to the noise tracking state 202. In the noise tracking state 202, the mean and variance determination, such as those discussed in conjunction with equations two and three, are periodically updated as described above. The adaption weight parameter, P, may be modified in this state based on the received audio signal. For example, the adaption weight parameter may be modified to limit the effect of updates during speech, in case the speech is not loud enough to be detected by the other states of the system. In certain cases, the adaptation weight is set to zero during the determination of equations three and four for any block where EEF(a) exceeds a mean value by a specific number of standard deviations. This hard threshold for outlier compensation adaptive step size selection can be expressed as

$$β ( a ) = \{ \begin{matrix}β , & EEF ( a ) < {m}_{E E F} ( a - 1 ) + u {σ}_{E E F} ( a - 1 ) \\ 0 , & EEF ( a ) \geq {m}_{E E F} ( a - 1 ) + u {σ}_{E E F} ( a - 1 )\end{matrix}$$

Once this threshold comparison is completed, the resulting value of P(a) is used in the update via equations two and three.

A more sophisticated model may use a constant value for the adaption weight to a first threshold and a linearly declining step size to a second threshold, where the step size reaches zero. In such a model, the β(a) parameter is effectively fixed for low values and then the β(a) parameter declines as input measurements increase for a given block for handling loud bursts of noise, such as a clank of a fork on a plate. In certain cases, the first threshold may be defined as be t₁(a−1)=m_{EEF}(a−1)+u₁σ_{EEF}(a−1), and the second threshold defined as t₂(a−1)=m_{EEF}(a−1)+u₂σ_{EEF}(a−1). In a soft outlier compensation threshold case, the step size may be determined by an equation β(a)=

$$\{ \begin{matrix}β & {t}_{1} ( a - 1 ) \geq E E F ( a ) \\ β \frac{E E F ( a ) - {t}_{1} ( a - 1 )}{( {u}_{2} - {u}_{1} ) σ ( a - 1 )} & {t}_{1} ( a - 1 ) \leq E E F ( a ) \leq {t}_{2} ( a - 1 ) \\ 0 & EE F ( a ) \geq {t}_{2} ( a - 1 ) .\end{matrix}$$

In certain cases, the detection threshold adaption state machine 200 may transition 210 out of the noise tracking state 202 to the speech freeze state 204 if the speech detection threshold is exceeded and speech is detected. This transition 210 occurs when the current value of EEF(a) is much larger than typical values for the current mean and variance statistics estimates. In this case, the block of data may contain significant speech content and the state transitions 210 to the speech freeze state 204. This state transition may be expressed as S(a)=NoiseTrack to S(a+1)=SpeechFreeze when EEF(a)>m_{EEF}(a−1)+k_{AdaptFreeze}σ_{EEF}(a−1). In the speech freeze state 204, the adaptation step size β_{speechFreeze} may be reduced or set to zero. This reduction in the adaptation step size reduces or stops adaption of the detection threshold. For example, the determination of the mean and standard deviation statistics used to update the detection threshold may be stopped, which in turn freezes the detection threshold. Stopping or slowing the adaptation of the detection threshold helps prevent possible desensitization of a system to speech due to adaptation of the detection during speech. The speech freeze state 204 generally operates on the assumption that a person speaking to the VAD system, such as when speaking command to the VAD system, will speak louder than the background noise to be heard by the VAD system. Thus, once speech has been detected, the adapted detection threshold will remain adequate given a relatively stable level of background noise.

In certain cases, there may be two transitions out of the speech freeze state 204. The first transition 212 out of the speech freeze state 204 returns the state to the Noise Tracking state 202, for example after detected speech stops, resuming the updating of the detection threshold. In certain cases, after a number of consecutive blocks where the value for EEF drops below the detection threshold, the transition 212 is triggered. The transition 212 from S(a)=SpeechFreeze to S(a+1)=NoiseTrack may be expressed as occurring when the condition EEF(a)<m_{EEF}(a−1)+k_{AdaptFreeze}σ_{EEF}(a−1) occurs for N_{Restart} consecutive blocks.

In certain cases, there may be a rapid step up in the level of background noise. In such cases, the system may transition to the speech freeze state due to an increase in the EEF. During the speech freeze state, EEF continues to be monitored and if the mean value for EEF increases to a second level threshold value above the detection threshold value, a second transition 214 to the noise step up state 206 may occur. The second transition 214 out of the speech freeze state 204 is intended to detect a case where the noise level has increased discontinuously. In such cases, the state may transition 214 from the speech freeze state 204 to the noise step up state 206, which may be expressed as S(a)=SpeechFreeze to S(a+1)=NoiseStepUp when the conditions are EEF(a)≥m_{EEF}(a−1)+k_{NoiseJump}σ_{EEF}(a−1).

In the noise step up state 206, the detection threshold associated with the speech freeze state 204 and noise tracking state 202 may be fixed and a noise step up alternate detection threshold may be determined. For example, an alternate statistic mean m_{EEF}(a) and variance σ_{EEF}(a) may be used to compute the detection threshold, with respect to equations two and three, using data collected within the noise step up state 206, using the weight parameter β_{StepUp}= 1/16 for # in equations two and three for the noise step up alternate detection threshold. During this state, the system counts 230 a number of blocks the system detects that satisfy a noise step up condition EEF(a)<m_{EEF}(a)+k_{Noiseump}σ_{EEF}(a). If the state machine remains in that state for a predetermined step up number of consecutive blocks, these noise step up detection threshold estimates statistics may be used to replace the original values in transition 216. After the statistics are reset, the state returns to the noise tracking state 202. If the EEF falls below the threshold for one or more blocks (e.g., does not exceed the predetermined number of consecutive blocks), according to the noise step up condition, the alternative statistics computed using β_{NoiseChange} may be discarded, and the state transitions 218 to the Noise Tracking state without updating the noise statistics. In accordance with aspects of the present disclosure, the number of consecutive blocks needed to cause the original values to be replaced may be relatively large, for example, corresponding to about two seconds of time. This relatively large number of blocks helps the system avoid erroneous transitions. If the transition occurs due to speech, then the system recovery requires a period of silence from the user for the detection threshold values to converge again.

In certain cases, the detection threshold adaption state machine 200 may transition 220 out of the noise tracking state 202 to the noise step down state 208 if the background noise drops in volume discontinuously, for example, when walking into a quiet room from a noisy environment. In such cases, the state may transition 220 from the noise tracking state 202 to the noise step down state 208, when the mean detection feature value has decreased below a step down level threshold value, which may be expressed EEF(a)≤m_{EEF}(a)+k_{NioseDrop}σ_{EEF}(a). The Noise Step Down state may be used to re-initialize the adaptation of the detection threshold, such as the mean and standard deviation (e.g., variance), when the acoustic background noise drops in volume.

In certain cases, when in the noise step down state 208, the detection threshold associated with the speech freeze state 204 and noise tracking state 202 continues to be updated and a parallel noise step down alternate detection threshold may also be determined. For example, an alternate statistic mean m_{EEF}(a) and variance σ_{EEF}(a) may be used to compute the detection threshold, with respect to equations two and three, using data collected within the noise step down state 208, using the weight parameter β_{stepDown}= 1/16 for β in equations two and three for the noise step down alternate detection threshold. During this state, the system counts 232 a number of blocks (e.g., a step down number of blocks) that the system detects satisfying the noise step down condition. If the noise step down condition EEF(a)<m_{EFF}(a)+k_{NoseDrop}σ_{EEF}(a) is satisfied in one or more N_{NoiseChange} onsecutive blocks while in the noise step state 208, then the noise step down alternate statistics may be used to replace the original values in transition 222. In certain cases, N_{NoiseChange} may be a predetermined number of consecutive blocks. If the EEF falls below a noise step down threshold such that the condition EEF(a)≥m_{EEF}(a)+k_{NoiseDrop}σ_{EEF}(a) is satisfied in one or more blocks (e.g., if the number of consecutive blocks does not exceed the predetermined number of blocks), the state transitions 224 back to the noise tracking state 202 and the noise step down alternate detection threshold statistics may be discarded.

It should be noted that the detection threshold adaption state machine 200 as described above may be adapted more generally to signals having noise beyond audio signals and speech, such as radio frequency signals. Depending on the specific signal to be detected, EEF may not be an appropriate measurement and another feature of the specific signal may be used in place of the EEF. Otherwise, the detection threshold adaption state machine 200 and equations provided above are generic and can be adapted to use the other feature of the specific signal.

### Voice Activity Shutdown

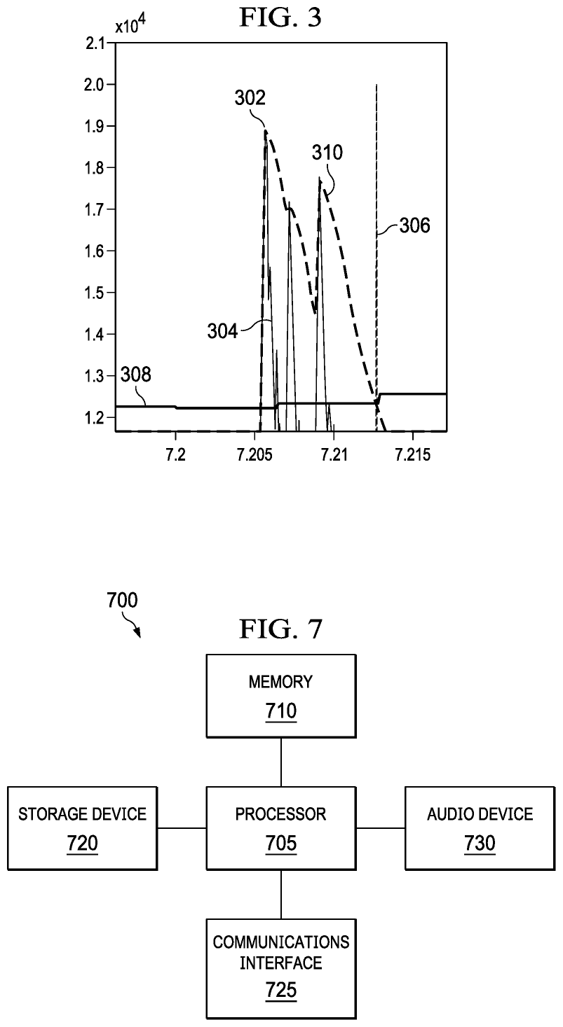

After a VAD system detects speech and triggered higher level processing is complete, the VAD system may be shut down rapidly to help save power. However, shutting down too rapidly could cause certain speech to be missed. For example, as shown in FIG. 3, in English, vowel sounds typically correspond with large EEF, such as EEF spike 302, as the voice box vibrates relatively more for vowels sounds as compared to consonant or fricative sounds, which typically are associated with substantially lower EEF, such as EEF tail 304. Ideally, shutdown 306 of the VAD system should be dynamically controlled to correspond with the EEF falling below the detection threshold 308.

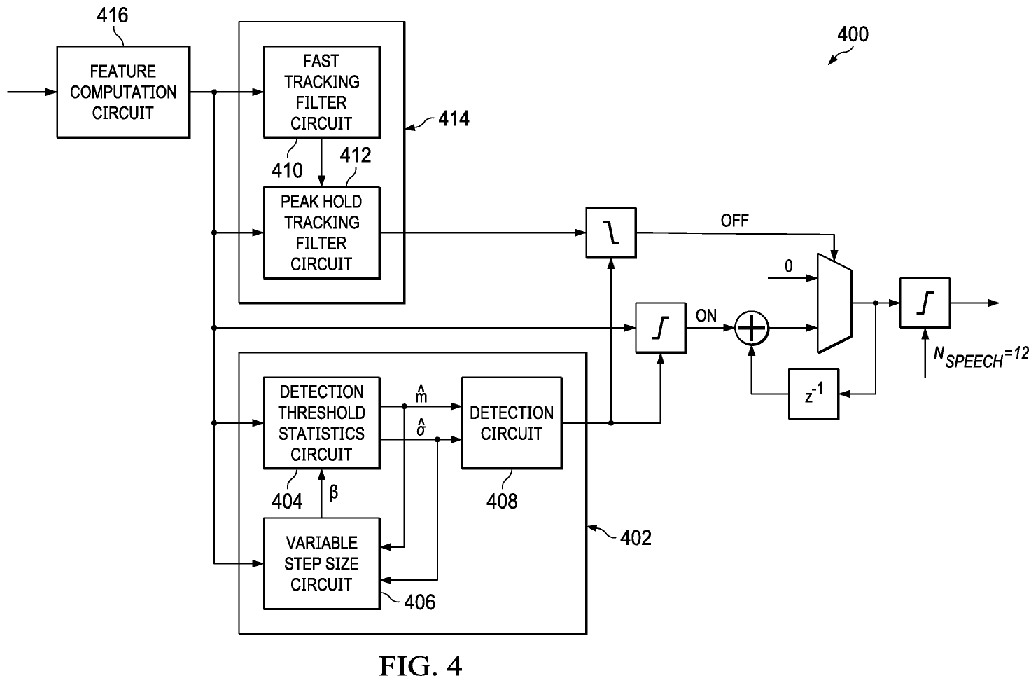

FIG. 4 illustrates an adaptive circuit 400, in accordance with aspects of the present disclosure. The adaptive circuit includes adaptive threshold circuitry 402, as discussed with respect to FIG. 2, which includes a detection threshold statistics circuit 404 for determining detection threshold statistics, such as the mean and standard deviation statistics of the EEF. The variable step size circuit 406 determines the β parameter indicating how much the detection threshold may be adjusted, and the detection circuit 408 determines whether the detection threshold has been met, for example, based on equation 1.

The adaptive circuit 400 includes voice activity shutdown circuit 414, which helps determine a shut-down time to return the adaptive circuit 400 to a pre-speech detection state. The voice activity shutdown circuit 414 receives feature information from a feature computation circuit 416. An example feature computation circuit 416 is discussed in conjunction with FIG. 1 with respect to receiving an input signal 102 and a noise signal 116, processing the received signals via FFT circuitry 106A, 106B, power spectrum circuitry 108, etc., to output an EFF via either multiplication circuit 124 and transformation circuitry 118. includes a pair of smoothing filters to extend the intervals where the smoothed detection metric exceeds the detection threshold, in order to detect the end of spoken commands or phrases that end with non-voiced sounds, such as fricative sounds like “f”, “s”, or consonants like “k” and “t.” A fast tracking filter circuit 410 with a relatively large loop bandwidth may be used to detect the rising edge of the EEF signal and is used as the final metric when the output signal is rising. While the signal is falling, the smoothed detection metric switches to the output of a peak hold tracking filter circuit 412 with relatively low loop bandwidth as compared to the fast tracking filter circuit 410. This slow decay on the falling edge of the detection metric extends the intervals identified as speech, so that non-voiced sounds are included when they occur at the end of a command. The equation for the fast tracking filter circuit 410 may be expressed as y_{fast}(a)=(1−g_{fast})y_{fast}(a−1)+g_{fast}EEF(a) and the equation for the peak hold tracking filter circuit 412 may be expressed as

$${y}_{hold} [ a ] = \{ \begin{matrix}{y}_{fast} [ a ] {y}_{fast} [ a ] > {y}_{hold} [ a - 1 ] \\ ( 1 - {g}_{hold} ) {y}_{hold} [ a - 1 ] + {g}_{hold} EEF [ a ] {y}_{fast} [ a ] \leq {y}_{hold} [ a - 1 ]\end{matrix} .$$

Generally, the fast tracking filter circuit 410 is setup such that the filter tracks the rising edge of an increasing EEF rapidly. If the EEF rises, the fast tracking filter 410 tracks and sets the fast hold tracking filter parameter y_{fast}(a) based on the EEF. The peak hold tracking filter circuit 412 is activated if the fast tracking filter parameter y_{fast}(a) falls below the peak hold parameter, then the peak hold tracking filter is used to update a peak hold metric 310 of FIG. 3 based on the EEF. This peak hold metric 310 then decays over time. The peak hold metric 310 is reset if, for example, the fast hold tracking filter parameter y_{fast}(a) again exceeds the decaying peak hold metric 310. After the peak hold metric decays below the detection threshold, a determination that the speech has ended may be made. As an example, an end of the speech interval may be determined when N_{End}=3 consecutive values of y_{hold}(a) fall below the detection threshold.

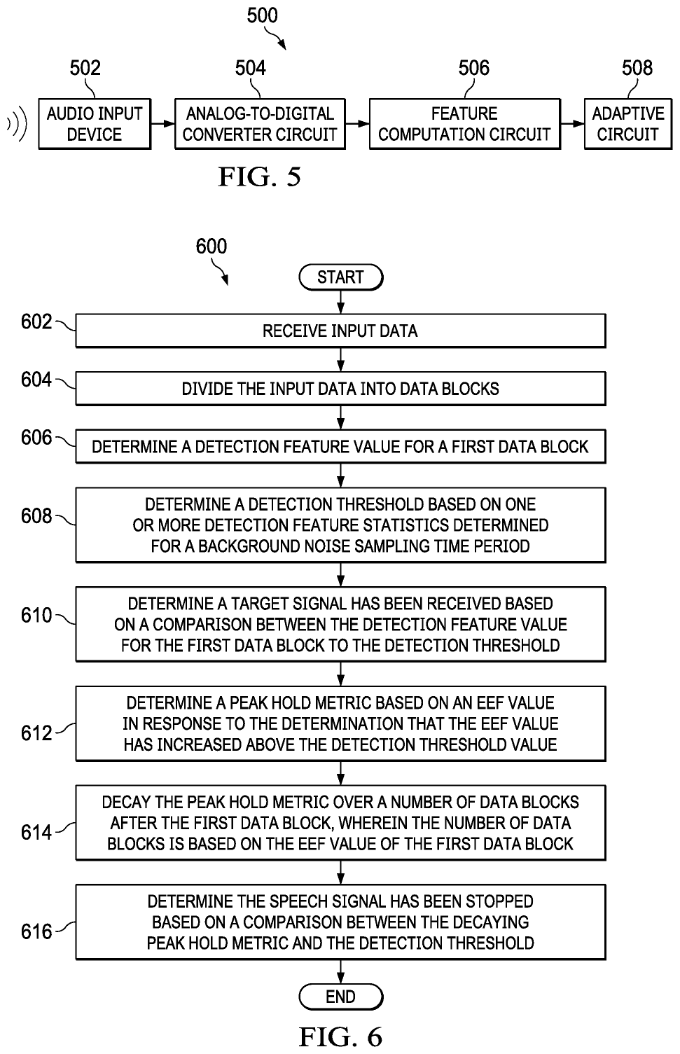

FIG. 5 is a block diagram illustrating an adaptive detection threshold VAD circuit, 500, in accordance with aspects of the present disclosure. The adaptive detection threshold VAD circuit 500 is an example circuit that performs target input detection. In this example embodiment, audio is received by an audio input device 502, which receives audio signals (e.g., sounds) from the environment. Examples of the audio input device 502 include microphone, microphone arrays, and the like. The audio received by the audio input device 502 are then converted from analog signals to digital signals via an analog-to-digital converter circuit 504. This digital signal passes into feature computation circuit 506, which determines an EFF of the digital signal. In certain cases, the feature computation circuit 506 may include circuitry configured to receive an input signal and noise signal and output features of the combined input and noise signal. An example feature computation circuit 506 is discussed in conjunction with FIG. 1 with respect to receiving an input signal 102 and a noise signal 116, processing the received signals via FFT circuitry 106A, 106B, power spectrum circuitry 108, etc., to output an EFF via either multiplication circuit 124 and transformation circuitry 118. The output EFF may be processed by adaptive circuit 508 to determine a detection threshold, such as via an adaptive threshold circuit, and whether the detection threshold has been met. An example adaptive circuit 508 is discussed in conjunction with FIG. 4.

FIG. 6 is a flow diagram illustrating a technique 600 for target input detection, in accordance with aspects of the present disclosure. In certain cases, the target input is a speech signal. At block 602 input data is received. In certain cases, the input may be audio input received, for example, by an adaptive detection threshold VAD circuit from one or more microphones. At block 604, the input data is divided into data blocks. This division may be based on the application of one or more windowing functions, such as a Hamming window. At block 606, a detection feature value may be determined for the first data block. In certain cases, the detection feature value may be an EEF value. In other cases, the detection feature may be based on the target input to be detected. As discussed above in conjunction with FIG. 1, the EEF may be determined based on a power spectrum and total energy of the first data block. At block 608, a detection threshold may be determined based on one or more detection feature statistics determined for a number of data blocks captured within a time interval. In certain cases, the time interval does not overlap with a time interval associated with the first data block. The EEF statistics may include a combination of mean EEF and standard deviation of the EEF for the time interval. At block 610, the detection feature of the first data block may be compared to the detection threshold to determine whether the first data block includes a speech signal. This determination may be used to, for example, activate speech specific signal processing to recognize and process detected speech.

In certain cases, the target input to be detected is speech and the detection feature value is an EEF value. In such cases, a peak hold metric may be used to determine when a speech signal has been stopped. At block 612, a peak hold metric based on the EEF may be determined in response to the determination that the mean EEF value has increased above the detection threshold. As an example, as discussed in conjunction with FIG. 4, a fast tracking filter may be used to detect a rising edge of an EEF signal and set the peak hold metric based on the EEF signal. At block 614, the peak hold metric may be decayed over a number of data blocks after the first data block. For example, as discussed in conjunction with FIG. 4, a peak hold tracking filter may be used to extend intervals identified as speech. The number of data blocks is based on the EEF value of the first data block. At block 616, the speech signal may be determined to be stopped based on a comparison between the decaying peak hold metric and the detection threshold. As an example, the speech signal may be determined to be stopped when the peak hold metric falls below the detection threshold for a number of data blocks.

As illustrated in FIG. 7, device 700 includes a processing element such as processor 705 that contains one or more hardware processors, where each hardware processor may have a single or multiple processor cores. Examples of processors include, but are not limited to a central processing unit (CPU) or a microprocessor. Although not illustrated in FIG. 7, the processing elements that make up processor 705 may also include one or more other types of hardware processing components, such as graphics processing units (GPUs), application specific integrated circuits (ASICs), field-programmable gate arrays (FPGAs), and/or digital signal processors (DSPs). In certain cases, processor 705 may be configured to perform the tasks described in conjunction with FIGS. 1-2, 4, and 5-6.

FIG. 7 illustrates that memory 710 may be operatively and communicatively coupled to processor 705. Memory 710 may be a non-transitory computer readable storage medium configured to store various types of data. For example, memory 710 may include one or more volatile devices such as random access memory (RAM). Non-volatile storage devices 720 can include one or more disk drives, optical drives, solid-state drives (SSDs), tap drives, flash memory, electrically programmable read only memory (EEPROM), and/or any other type memory designed to maintain data for a duration time after a power loss or shut down operation. The non-volatile storage devices 720 may also be used to store programs that are loaded into the RAM when such programs executed.

Persons of ordinary skill in the art are aware that software programs may be developed, encoded, and compiled in a variety of computing languages for a variety of software platforms and/or operating systems and subsequently loaded and executed by processor 705. In one embodiment, the compiling process of the software program may transform program code written in a programming language to another computer language such that the processor 705 is able to execute the programming code. For example, the compiling process of the software program may generate an executable program that provides encoded instructions (e.g., machine code instructions) for processor 705 to accomplish specific, non-generic, particular computing functions.

After the compiling process, the encoded instructions may then be loaded as computer executable instructions or process steps to processor 705 from storage 720, from memory 710, and/or embedded within processor 705 (e.g., via a cache or on-board ROM). Processor 705 may be configured to execute the stored instructions or process steps in order to perform instructions or process steps to transform the computing device into a non-generic, particular, specially programmed machine or apparatus. Stored data, e.g., data stored by a storage device 720, may be accessed by processor 705 during the execution of computer executable instructions or process steps to instruct one or more components within the computing device 700. Storage 720 may be partitioned or split into multiple sections that may be accessed by different software programs. For example, storage 720 may include a section designated for specific purposes, such as storing program instructions or data for updating software of the computing device 700. In one embodiment, the software to be updated includes the ROM, or firmware, of the computing device. In certain cases, the computing device 700 may include multiple operating systems. For example, the computing device 700 may include a general-purpose operating system which is utilized for normal operations. The computing device 700 may also include another operating system, such as a bootloader, for performing specific tasks, such as upgrading and recovering the general-purpose operating system, and allowing access to the computing device 700 at a level generally not available through the general-purpose operating system. Both the general-purpose operating system and another operating system may have access to the section of storage 720 designated for specific purposes.

In certain implementations, a detection circuit comprises one or more non-programmable circuits that collectively perform the tasks described above regarding FIGS. 1-6. Such circuits include one or more logic gates (e.g., AND gates, OR gates, inverters, NAND gates, etc.), flip-flops, transistors, comparators, resistors, capacitors, and other types of hardware circuit components, etc. It may be understood that circuits may be implemented at either software, hardware, or a combination thereof. That is, software may be implemented as dedicated hardware circuits and vice versa.

The one or more communications interfaces may include a radio communications interface for interfacing with one or more radio communications devices. In certain cases, elements coupled to the processor may be included on hardware shared with the processor. For example, the communications interfaces 725, storage, 720, and memory 710 may be included, along with other elements such as the digital radio, in a single chip or package, such as in a system on a chip (SOC). Computing device may also include input and/or output devices, not shown, examples of which include sensors, cameras, human input devices, such as a mouse, keyboard, touchscreen, monitors, display screen, tactile or motion generators, speakers, lights, etc. An audio device 730 may include one or more components to gather and process audio data. For example, the audio device 730 may include a microphone, analog-to-digital converter circuit, and a VAD circuit as described in FIGS. 1, 4 and 5. Processed input, for example from the audio device 730, may be output from the computing device 700 via the communications interfaces 725 to one or more other devices.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A method for target input detection, comprising:
receiving input data;
dividing the input data into data blocks;
determining a detection feature value for a first data block;
determining a detection threshold based on a set of detection feature statistics determined for a background sampling time period; and
determining a target signal has been received based on a comparison between the detection feature value for the first data block to the detection threshold.

2. The method of claim 1, wherein the set of feature statistics comprise a combination of mean and standard deviation values for the background sampling time period.

3. The method of claim 2, further comprising updating the detection threshold based on a predetermined period.

4. The method of claim 2, further comprising stopping the updating of the detection threshold based on a determination that the target signal has been received.

5. The method of claim 4, further comprising resuming the updating of the detection threshold based on a determination that the target signal has ended.

6. The method of claim 4, further comprising:
determining a mean detection feature value has increased above a step up level threshold value;
determining a set of alternate detection feature statistics based on the mean and standard deviation of the detection feature value while the mean detection feature value is above the step up level threshold value;
determining a consecutive number of blocks having the mean detection feature value above the step up level threshold value;
replacing the set of detection feature statistics with the set of alternate detection feature statistics if the number of blocks exceeds a predetermined step up number of blocks; and
discarding the set of alternate detection feature statistics if the number of blocks does not exceed the predetermined step up number of blocks.

7. The method of claim 4, further comprising:
determining a mean detection feature value has decreased below a step down level threshold value;
determining a set of alternate detection feature statistics based on the mean and standard deviation of the detection feature value while the mean detection feature value is below the step down level threshold value;
determining a consecutive number of blocks having the mean detection feature value below the step down level threshold value;
replacing the detection feature statistics with the set of alternate detection feature statistics if the number of blocks exceeds a predetermined step down number of blocks; and
discarding the set of alternate detection feature statistics if the number of blocks does not exceed the predetermined step down number of blocks.

8. The method of claim 1, wherein the detection feature comprises an energy entropy feature (EEF) value, wherein the target signal comprises a speech signal, and further comprising:
determining a peak hold metric based on the EEF value in response to the determination that the EEF value has increased above the detection threshold value;
decaying the peak hold metric over a number of data blocks after the first data block, wherein the number of data blocks is based on the EEF value of the first data block; and
determining the speech signal has been stopped based on a comparison between the decaying peak hold metric and the detection threshold.

9. The method of claim 8, further comprising:
resetting the peak hold metric based on a second EEF value determined for a second data block received after the first data block.

10. A non-transitory program storage device comprising instructions stored thereon to cause one or more processors to:
receive input data;
divide the input data into data blocks;
determine a detection feature value for a first data block;
determine a detection threshold based on a set of detection feature statistics determined for a background sampling time period; and
determine a target signal has been received based on a comparison between the detection feature value for the first data block to the detection threshold.

11. The non-transitory program storage device of claim 10, wherein the set of detection feature statistics comprise a combination of mean and standard deviation of the detection feature values for the background sampling time period.

12. The non-transitory program storage device of claim 10, wherein the instructions stored thereon further cause the one or more processors to update the detection threshold based on a predetermined period.

13. The non-transitory program storage device of claim 12, wherein the instructions stored thereon further cause the one or more processors to stop the updating of the detection threshold based on a determination that the target signal has been received.

14. The non-transitory program storage device of claim 13, wherein the instructions stored thereon further cause the one or more processors to resume the updating of the detection threshold based on a determination that the target signal has ended.

15. The non-transitory program storage device of claim 13, wherein the instructions stored thereon further cause the one or more processors to:
determine a mean detection feature value has increased above a step up level threshold value;
determine a set of alternate detection feature statistics based on the mean and standard deviation of the detection feature value while the mean detection feature value is above the step up level threshold value;
determine a consecutive number of blocks having the mean detection feature value above the step up level threshold value;
replace the set of detection feature statistics with the set of alternate detection feature statistics if the number of blocks exceeds a predetermined step up number of blocks; and
discard the set of alternate detection feature statistics if the number of blocks does not exceed the predetermined step up number of blocks.

16. The non-transitory program storage device of claim 13, wherein the instructions stored thereon further cause the one or more processors to:
determine a mean detection feature value has decreased below a step down level threshold value;
determine a set of alternate detection feature statistics based on the mean and standard deviation of the detection feature value while the mean detection feature value is below the step down level threshold value;
determine a consecutive number of blocks having the mean detection feature value below the step down level threshold value;
replace the set of detection feature statistics with the set of alternate detection feature statistics if the number of blocks exceeds a predetermined step down number of blocks; and
discard the set of alternate detection feature statistics if the number of blocks does not exceed the predetermined step down number of blocks.

17. The non-transitory program storage device of claim 10, wherein the detection feature comprises an energy entropy feature (EEF) value, wherein the target signal comprises a speech signal, and wherein the instructions stored thereon further cause the one or more processors to:
determine a peak hold metric based on the EEF value in response to the determination that the EEF value has increased above a detection threshold value;
decay the peak hold metric over a number of data blocks after the first data block, wherein the number of data blocks is based on the EEF value of the first data block; and
determine the speech signal has been stopped based on a comparison between the decaying peak hold metric and the detection threshold.

18. The non-transitory program storage device of claim 17, wherein the instructions stored thereon further cause the one or more processors to:
reset the peak hold metric based on a second EEF value determined for a second data block received after the first data block.

19. A detection circuit comprising:
receiving circuitry configured to receive input data;
windowing circuitry configured to divide the input data into data blocks;
feature computation circuitry configured to determine a detection feature value for a first data block;
adaptive threshold circuitry configured to determine a detection threshold based on a set of detection feature statistics determined for a background noise sampling time period; and
detection circuitry configured to determine a signal has been received based on a comparison between the detection feature value for the first data block to the detection threshold.

20. The circuit of claim 19, wherein the set of detection feature statistics comprise a combination of mean and standard deviation of the detection feature values for the background sampling time period.
